(19) United States
(12) Patent Application Publication
(10) Pub. No.: US 2010/0326852 A1
(43) Pub. Date: Dec. 30, 2010

(54) CASING FOR A MULTIMEDIA STORAGE MEDIUM AND/OR DATA STORAGE MEDIUM

(75) Inventor: Jean-Noel Fournillier, Lyon (FR)

Correspondence Address: YOUNG & THOMPSON, 209 Madison Street, Suite 500, Alexandria, VA, 22314, US

(73) Assignee: KEY SOLUTIONS, Paris (FR)

(21) Appl. No.: 12/865,734

(22) PCT Filed: Feb. 6, 2009
(86) PCT No.: PCT/FR2009/000136

§ 371 Date: Sep. 10, 2010

Related U.S. Application Data
(60) Provisional application No. 61/034,232, filed on Mar. 6, 2008.

(30) Foreign Application Priority Data
Feb. 14, 2008 (FR) 08 00810

(51) Int. Cl. B65D 85/57; B23P 19/00

(52) U.S. Cl. 206/308.1; 29/428; 206/307

(57) ABSTRACT

A housing for a multimedia carrier and/or a data carrier includes first and second members (2, 3) each including a shell (5, 6) made of a metal connected to a plastic plate (19, 20), and flexible connection members (4) defining a hinge and attached inside housings (31, 34) respectively formed in the plates (19, 20) in order to ensure the flat opening of the housing (1).

The present invention relates to an assembly method for producing a casing for a multimedia storage medium and/or data storage medium and to a casing for a multimedia storage medium and/or data storage medium having a linking device providing a hinge between the two shells forming said casing.

The casing according to the present invention enables any multimedia storage media or data storage media, for example compact discs, video compact discs, magnetic cards, SIM cards, credit cards, etc., to be stored or stowed away.

Casings or the like, which have two shells joined together by way either of American type hinges or of independent flexible hinges, are known.

The assembly method according to the present invention for producing a casing for a multimedia storage medium and/or data storage medium consists in taking pre-shaped plastic sheets comprising, at one of their peripheral edges, housings provided with locking means for joining them together, in introducing into the housings hinge-forming linking elements, in blocking the linking elements inside the housings, and in fixing the plastic sheets in a rigid shell, which comprises turned-up peripheral edges, such that the rear turned-up peripheral edges of each rigid shell cover the linking elements in order to form an invisible hinge for opening said casing.

According to another embodiment, the assembly method according to the present invention consists in taking pre-shaped plastic sheets comprising, at one of their peripheral edges, housings provided with locking means for joining them together, in fixing the plastic sheets in a rigid shell, which comprises turned-up peripheral edges, such that the slots or grooves in the rear turned-up peripheral edges are positioned opposite the housings, in introducing into the housings hinge-forming linking elements, and in blocking the linking elements inside the housings, in order to open said casing.

The assembly method according to the present invention consists in that each hinge-forming linking element is made of flexible plastic comprising two tabs provided with a back, said backs of each tab being joined together at their free ends and over the entire height of said tabs by way of a groove or a thin bead constituting a fold or a hinge so that the two tabs can move relative to one another.

The assembly method according to the present invention consists in that the linking element consists of two L-shaped tabs each having a short back extended perpendicularly by an arm which is introduced into the housings of each plastic sheet by way of an opening.

The assembly method according to the present invention consists in that each tab of the linking elements has a shaping, a protrusion or a tooth engaging with the locking means having a complementary form provided in each housing in order to fix and retain each linking element.

The assembly method according to the present invention consists in that each tab of the linking elements has, between the tooth and the back, a holding trough into which is introduced a retaining arm belonging to each housing in order to complete the fixing and retaining of each linking element.

The assembly method according to the present invention consists in that, while the plastic sheets are fixed inside the rigid shells, the rear turned-up peripheral edges press against the backs of each tab of the corresponding linking element, preventing the removal of said linking element from each housing.

The assembly method according to the present invention consists in that the thin triangular bead of each hinge-forming linking element is set back with respect to the rear turned-up peripheral edges of each rigid shell, enabling the production of a casing having a totally flat back which is able to receive printing.

The casing for a multimedia storage medium and/or data storage medium according to the present invention has a first and a second element each consisting of a metal shell secured to a plastic sheet and flexible hinge-forming linking elements which are fixed inside housings respectively formed in the plates, in order to make it possible to open said casing.

The casing for a multimedia storage medium and/or data storage medium according to the present invention has on each shell an upper, lower, front and rear turned-up peripheral edge provided with a collar directed towards the inside of said shells for snap-fastening and retaining the corresponding sheet.

The casing for a multimedia storage medium and/or data storage medium according to the present invention has, on at least one of the sheets, at least one holding means for positioning and retaining a magnetic card or the like.

The casing for a multimedia storage medium and/or data storage medium according to the present invention has, on at least one of the sheets, at least one holding means for positioning and retaining a magnetic card or the like, while the other sheet comprises retaining means for snap-fastening a compact disc or video or the like.

The casing for a multimedia storage medium and/or data storage medium according to the present invention has holding means that consist of a pocket and of a clip secured to the corresponding sheet.

The casing for a multimedia storage medium and/or data storage medium according to the present invention has a clip that is provided inside the pocket.

The casing for a multimedia storage medium and/or data storage medium according to the present invention has a pocket, the inlet to which is located either in the upper part or to the left-hand or right-hand side.

The casing for a multimedia storage medium and/or data storage medium according to the present invention has a clip that is located opposite the inlet to the pocket.

The casing for a multimedia storage medium and/or data storage medium according to the present invention has holding means that consist of a peripheral frame formed by a rib having an approximately rounded relief delimiting an internal surface, said peripheral frame having, at least on two opposite edges, an elastically deformable clip for positioning and retaining the magnetic card or a SIM card or the like.

The casing for a multimedia storage medium and/or data storage medium according to the present invention has, on each clip, a tab cut from the bottom of the plastic sheet and extended at its end by a push button in order to exert on said tab a pressure which elastically deforms it in order to introduce the magnetic card or a SIM card or the like.

The casing for a multimedia storage medium and/or data storage medium according to the present invention has a clip, the tab of which comprises in its approximately vertical extension and underneath the push button a protrusion in the form of a lip delimiting with said tab a space for holding and retaining the magnetic card or a SIM card or the like.

The appended drawings, given by way of example, will make it easier to understand the invention, its features and the advantages it can provide:

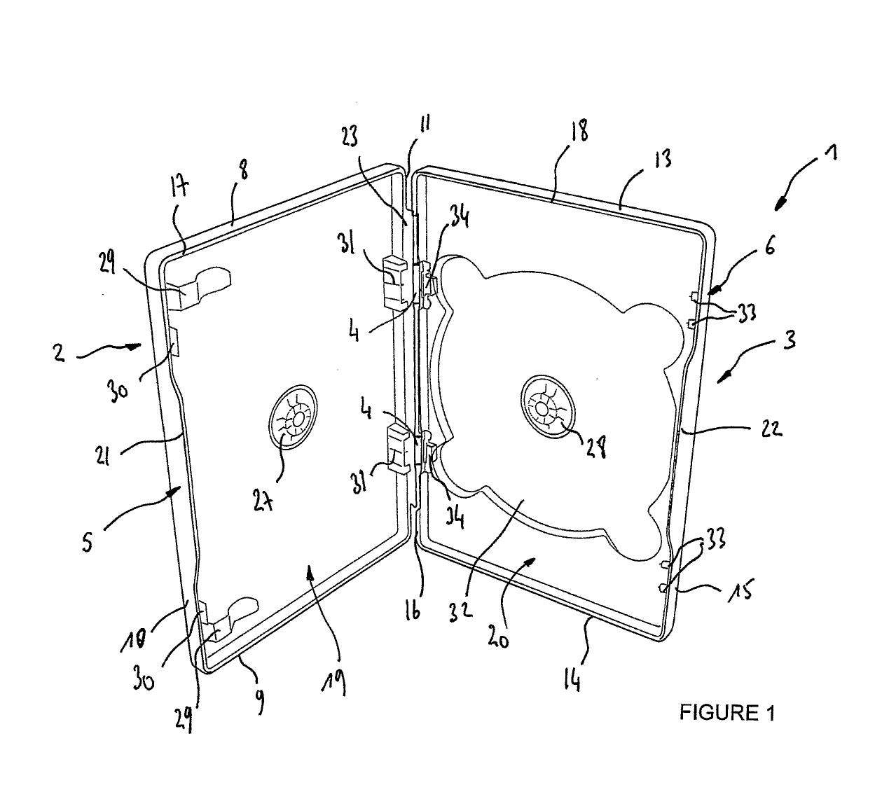

FIG. 1 is a perspective view illustrating the casing for a multimedia storage medium and/or data storage medium according to the present invention in the open position.

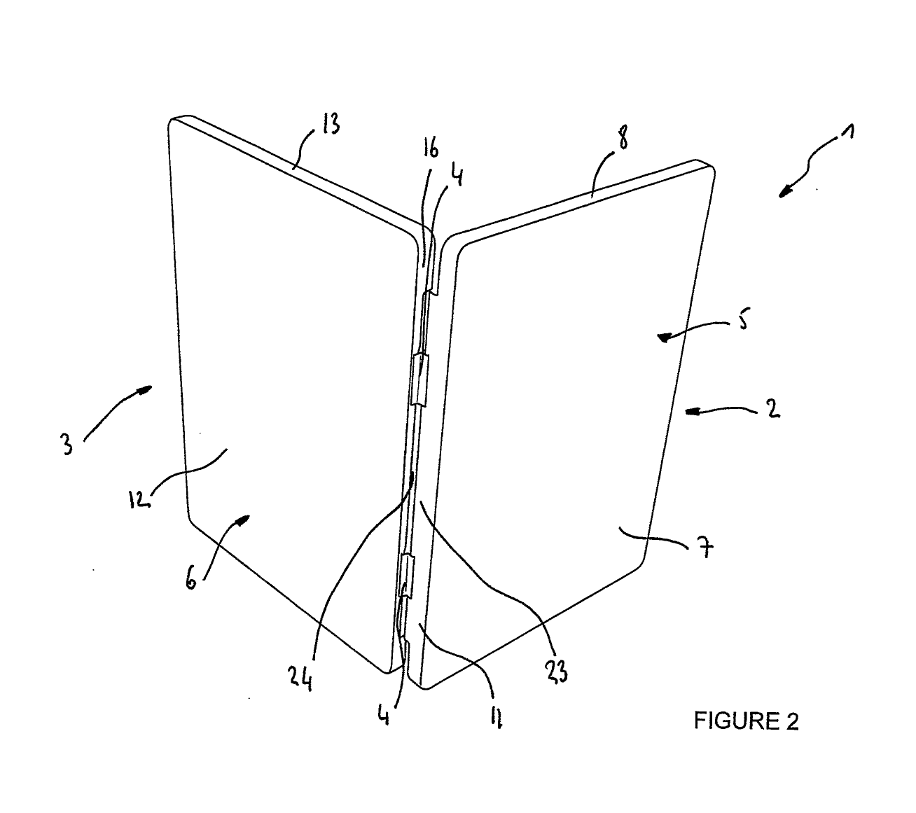

FIG. 2 is a perspective view representing the casing for a multimedia storage medium and/or data storage medium according to the present invention from behind and in the open position.

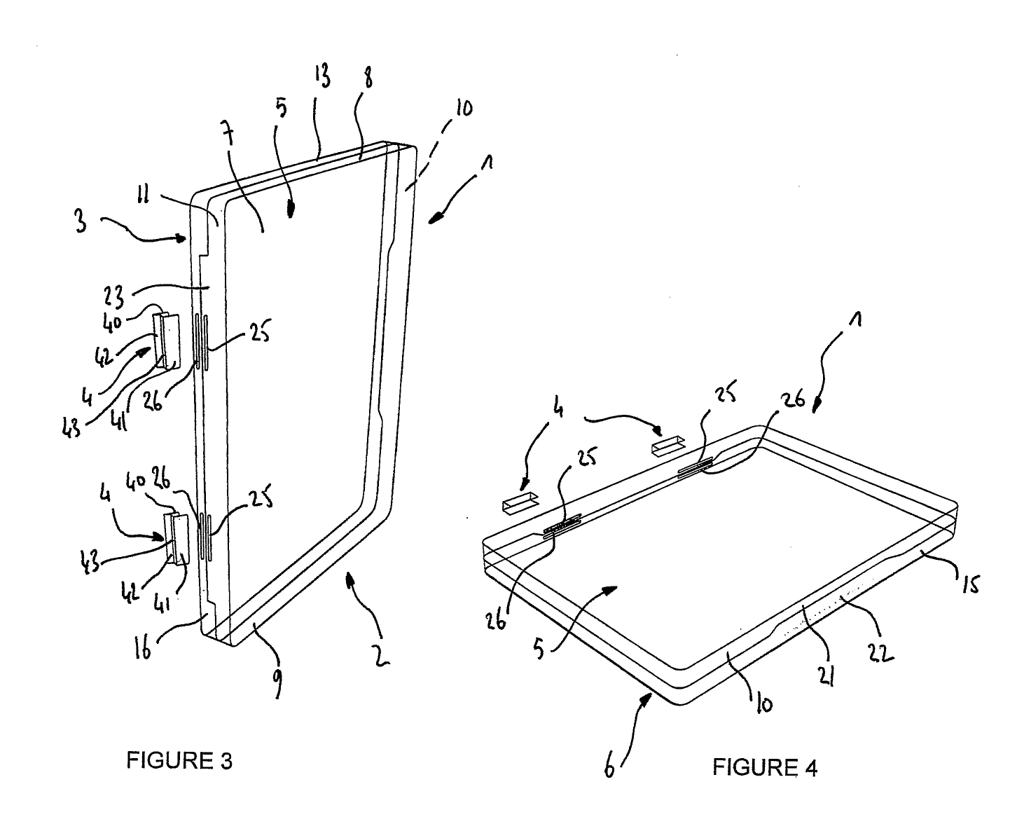

FIGS. 3 and 4 are perspective views showing the casing for a multimedia storage medium and/or data storage medium and the hinge-forming linking elements according to the present invention.

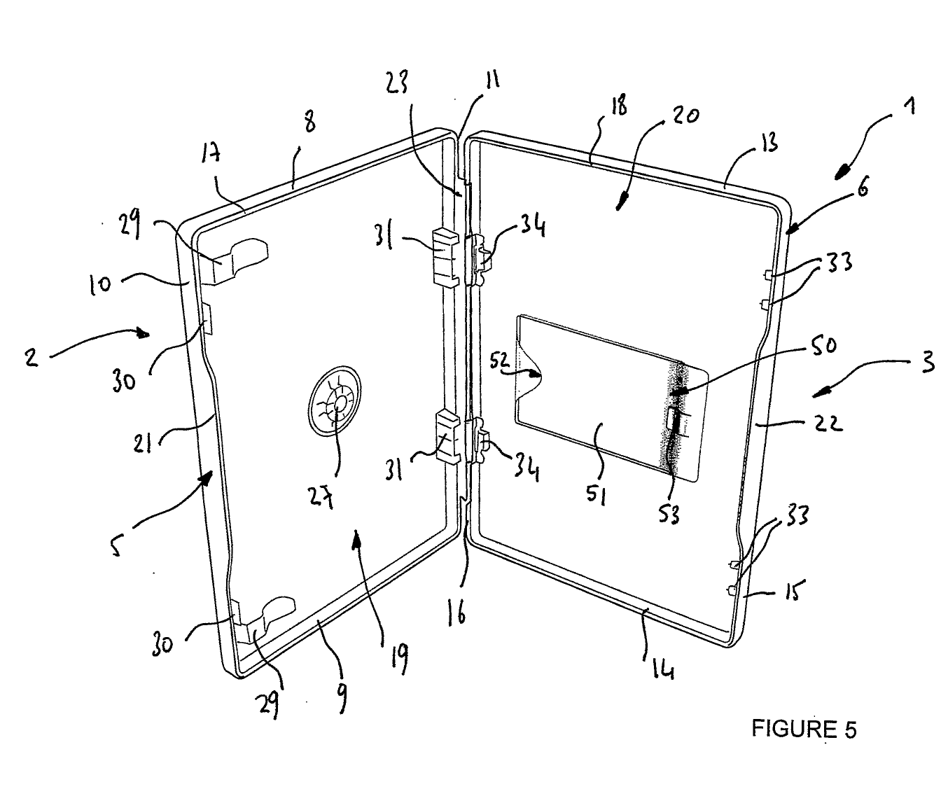

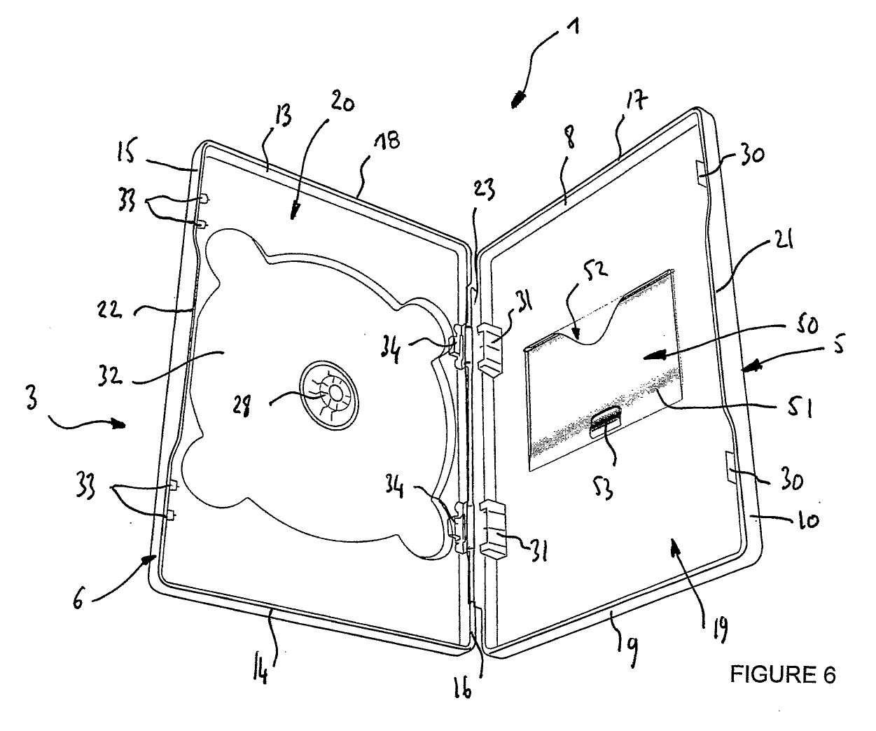

FIGS. 5 and 6 are perspective views illustrating the casing for a multimedia storage medium and/or data storage medium having holding means for positioning and retaining a magnetic card or the like.

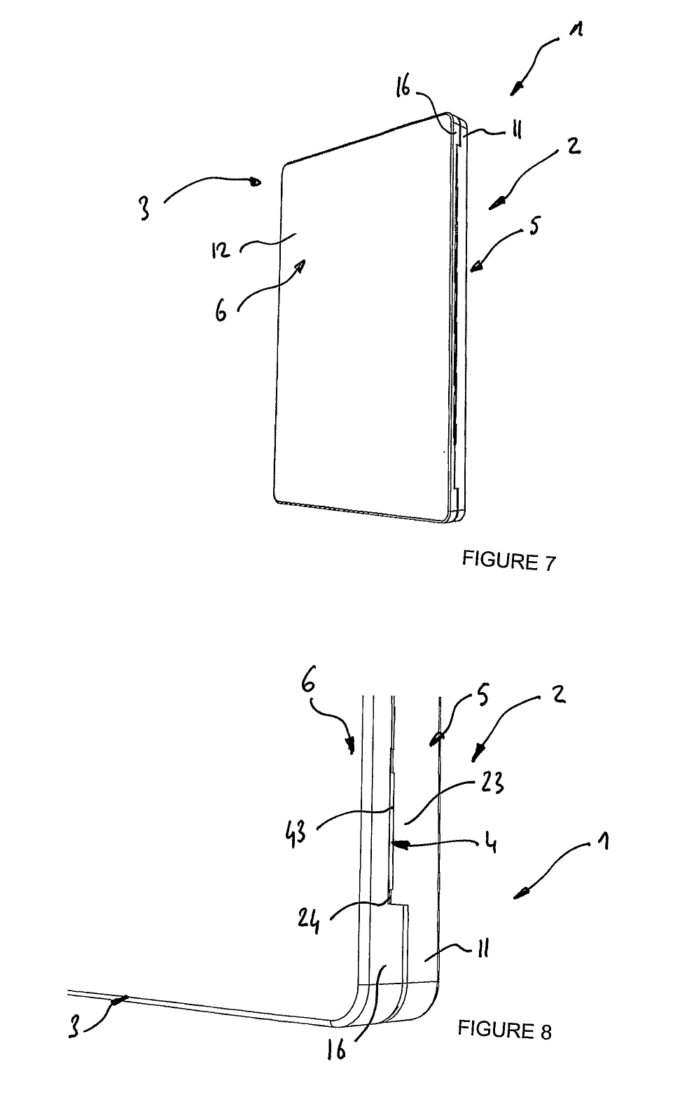

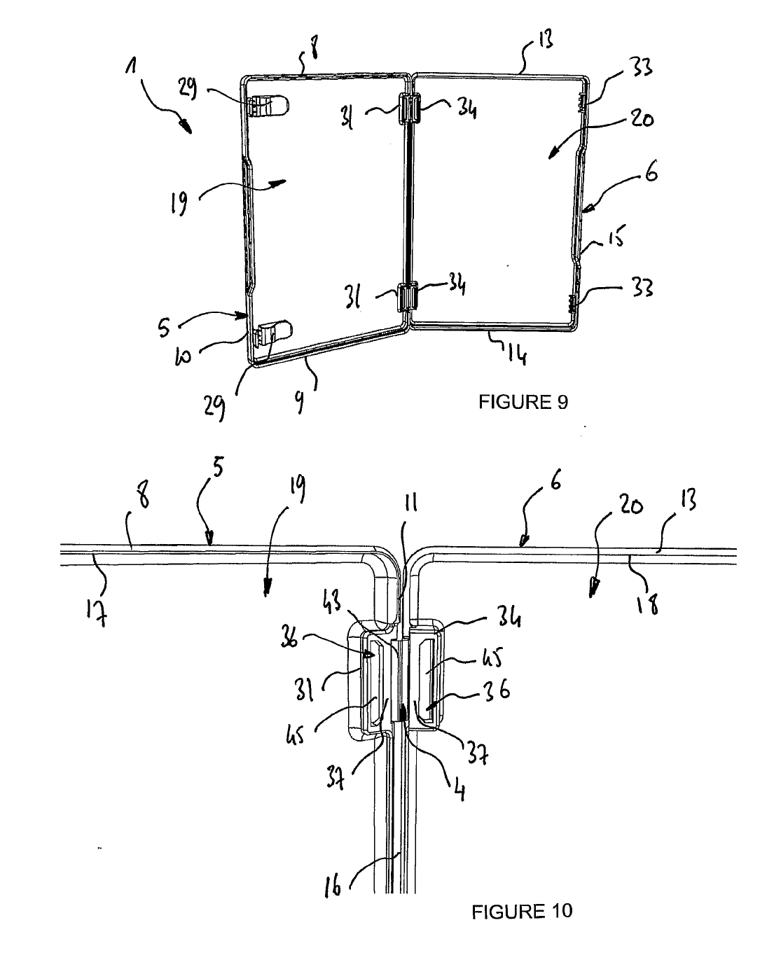

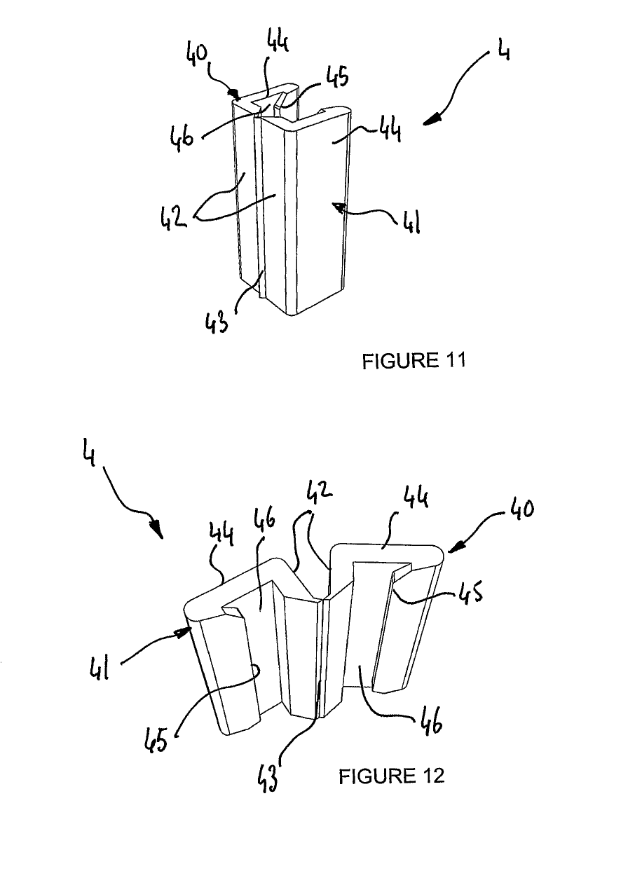

FIGS. 7 to 15 are views showing a variant of the hinge-forming linking elements of the casing for a multimedia storage medium and/or data storage medium according to the present invention.

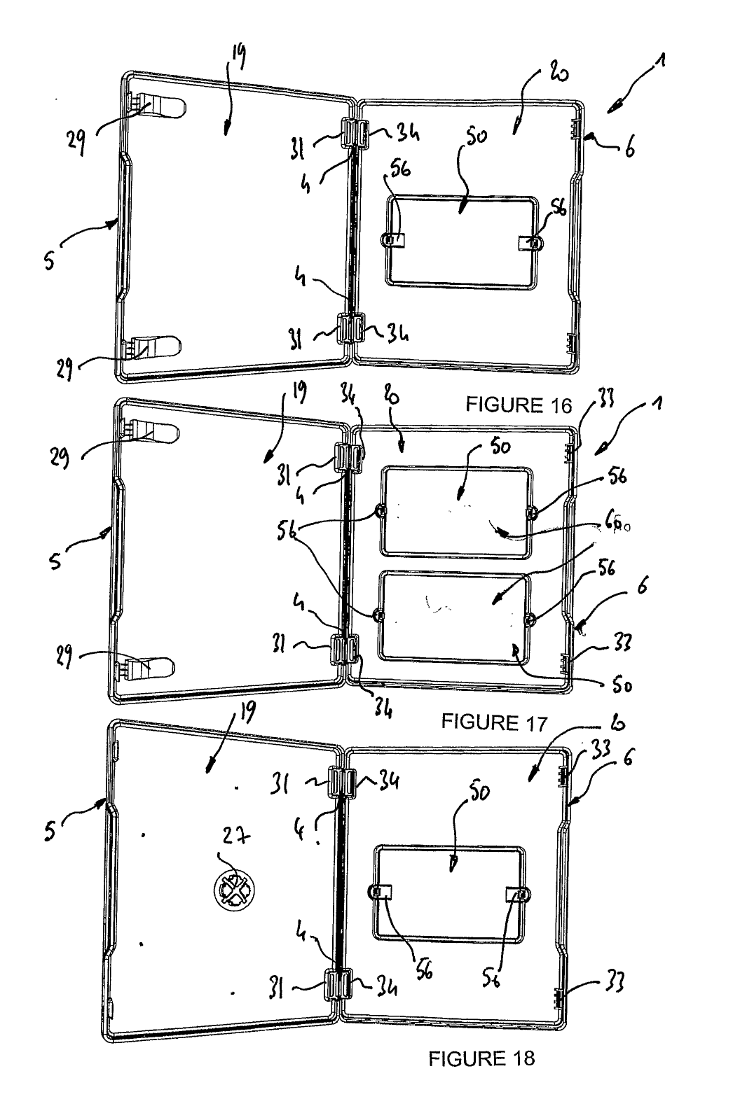

FIGS. 16 to 21 are views representing a variant of the holding means for positioning and retaining a magnetic card or the like in the casing for a multimedia storage medium and/or data storage medium according to the present invention.

FIGS. 1 to 4 show a casing 1 for a multimedia storage medium and/or data storage medium having a first and a second element 2, 3 which are joined together by at least one hinge-forming linking element 4.

Each first and second element 2, 3 consists of a rigid shell 5, 6 which can be made of metal, an alloy or wood, or of plastic, or of rigid cardboard, or of paper.

The shell 5 has a bottom 7 delimited by continuous upper 8, lower 9, front 10 and rear 11 turned-up peripheral edges. The shell 6 has a bottom 12 delimited by continuous upper 13, lower 14, front 15 and rear 16 turned-up peripheral edges.

Each upper 8, 13, lower 9, 14, front 10, 15 and rear 11, 16 turned-up peripheral edge has a collar 17, 18 directed towards the inside of each rigid shell 5, 6 for snap-fastening and retaining a plastic sheet 19, 20 inside said shells 5, 6.

The collars 17, 18 are provided continuously on the upper 8, 13, lower 9, 14, and front 10, 15 turned-up peripheral edges and extend in part on the rear turned-up peripheral edges 11, 16.

Thus, the collars 17, 18 are continuous from one turned-up peripheral edge to another, that is to say for the upper 8, 13, lower 9, 14, and front 10, 15 turned-up peripheral edges, in order to end in the upper and lower part of the rear turned-up peripheral edges 11, 16 of each shell 5, 6.

The front turned-up peripheral edges 10 and 15 of the shells 5 and 6 are each provided with an indentation 21, 22 to be gripped by the user in order to move the casing 1 from the closed position to the open position and vice versa.

The rear turned-up peripheral edge 11 of the shell 5 has a straight extension 23 centered on the length of said edge. The straight extension 23 has open-ended slots or grooves 25 for one of the ends of the hinge-forming linking elements 4 to pass through.

The rear turned-up peripheral edge 16 of the shell 6 has a notch 24 holding, while the shells 5 and 6 are assembled together, the straight extension 23 of the rear turned-up peripheral edge 11 of the shell 5.

Below the notch 24, the rear turned-up peripheral edge 16 has open-ended slots or grooves 26 positioned facing those 25 of the straight extension 23 for the other end of the hinge-forming linking elements 4 to pass through.

Each hinge-forming linking element 4 is made of flexible plastic comprising two tabs 40, 41 provided with a back 42. The backs 42 of each tab 40, 41 are joined together at their free ends and over the entire height of said tabs by way of a groove or thin bead 43 constituting a fold or a hinge in order that the two tabs can move with respect to one another.

Each tab 40, 41 has shapings or protrusions (not shown) for fixing and retaining each linking element 4 in the first and second elements 2, 3.

In the closed position, the casing 1 has a flat back which is continuous and wide on account of the assembly of the rear turned-up peripheral edges 11, 16 of the shells 5, 6.

Each first and second element 2, 3 has, inside the shells 5, 6, a plastic sheet 19, 20, each having retaining means 27, 28 in its middle for snap-fastening a compact disc.

Next to the front turned-up peripheral edge 10 of the shell 5, the sheet 19 has clips 29 for positioning and retaining a booklet or any other paper medium. The sheet 19 also has tabs 30 next to the front turned-up peripheral edge 10 of the shell 5 and between the clips 29 and the indentation 21 for locking the casing 1 and holding it in the closed position.

Opposite the locking tabs 30 and at the rear turned-up peripheral edge 11 of the shell 5, the sheet 19 has housings 31 which are positioned while said sheet 19 is fixed in said shell 5 opposite the open-ended slots or grooves 25 in the straight extension 23 of said rear turned-up peripheral edge 11.

The internal part of the housings 31 contains locking means (not shown) having a form complementary to the shapings provided on each tab 41 of the linking elements 4 in order to block said tabs in each housing.

To this end, the tabs 41 are introduced through the open-ended slots or grooves 25 in the straight extension 23 of said rear turned-up peripheral edge 11 of the shell 5 so as to penetrate inside the housing 31 in order to be retained in the latter.

The sheet 20 may have, centered around its retaining means 28, an indentation 32 having an approximately circular profile for holding, for example, one or more compact disc(s) (not shown). The retaining means 28 in the sheets 20 are provided in an appropriate form depending on the multimedia storage medium and/or data storage medium to be stored, protected and stowed away.

Next to the front turned-up peripheral edge 15 of the shell 6 and on either side of the indentation 22, the sheet 20 has protrusions 33 engaging with the tabs 30 of the sheet 19 in order to lock the casing 1 and hold it in the closed position.

Opposite the protrusions 33 and at the rear turned-up peripheral edge 16 of the shell 6, the sheet 20 comprises housings 34 which are positioned while said sheet 20 is fixed inside said shell 6 opposite the open-ended slots or grooves 26 below the notch 24 in said rear turned-up peripheral edge 16.

The internal part of the housings 34 contains locking means (not shown) having a form complementary to the shapings provided on each tab 40 of the linking elements 4 in order to block said tabs in each housing.

To this end, the tabs 40 are introduced through the open-ended slots or grooves 26 in the rear turned-up peripheral edge 16 of the shell 6 so as to penetrate inside the housing 34 in order to be retained in the latter.

It can be seen that the hinge-forming linking elements 4 produce a wide opening of the casing 1, that is to say that the first and second elements 2, 3 can be positioned approximately in the same plane, or flat, or in parallel planes or planes at 180°.

FIGS. 5 and 6 show the casing 1, one or both of the sheets 19, 20 of which have one or more holding means 50 for positioning and retaining a magnetic card or a SIM card or the like.

Each holding means 50 in the corresponding sheet 19, 20 may have an inlet either on the left-hand or right-hand side or at the top in order to introduce the corresponding card.

The holding means 50 consist of a pocket 51 secured to the corresponding sheet 19, 20 and having an inlet 52 located either on the left-hand or right-hand side or in its upper part.

Opposite the inlet 52 and inside the pocket 51, the holding means 50 have a clip 53 enabling, by elastic deformation, the withdrawal of the magnetic card or the like from inside said pocket.

FIGS. 7 to 15 show a variant relating to the hinge-forming linking elements 4 such that the casing 1 has, in the closed position, a back which is flat, continuous and with no hinge visible.

The back of the casing 1 in the closed position consists more particularly of the rear turned-up peripheral edges 11, 16 of the rigid shells 5, 6 of each element 2, 3 being positioned in the same plane.

In order for the back of the casing 1, in the closed position, to be continuous between the rear turned-up peripheral edges 11, 16 of each rigid shell 5, 6, it is necessary that the hinge-forming linking elements 4 be located between the elements 2, 3 so as to be invisible or as invisible as possible in order not to impede the continuity between said edges.

Likewise, the hinge-forming linking elements 4 must be located so as to enable the casing 1 to be laid flat in the open position, that is to say that the first and second elements 2, 3 can be positioned in the same plane.

To this end, the plastic sheets 19, 20 fixed inside the rigid shells 5, 6 must have, in the direction of the rear turned-up peripheral edges 11, 16, housings 31, 34 in the overthicknesses, each having an opening 35 forming an inlet which is directed in the direction of said rear turned-up peripheral edges 11, 16 and enables the linking element 4 to be introduced.

The overthicknesses delimiting the housings 31, 34 are provided respectively at a similar height to those in the rear turned-up peripheral edges 11, 16 of the rigid shells 5, 6, while the opening 35 in each housing 31, is provided to be closed or blocked off by the corresponding rear turned-up peripheral edges 11, 16 after the plastic sheets 19, 20 have been fitted inside said rigid shells 5, 6.

Likewise, each housing 31, 34 has, perpendicularly to the opening 35 forming an inlet and on the top of the housing, an open notch 36 delimiting a retaining arm 37.

Thus, in order to join the housings 31 of the plastic sheet 19 secured to the rigid shell 5 to the housings 34 of the plastic sheet 20 fixed in the rigid shell 6 of the casing 1, it is necessary for the hinge-forming linking element 4 to have a particular configuration in order for the opening and closing movements of said casing to take place without said linking element ever appearing at the back of said casing.

The linking element 4 consists of two L-shaped tabs 40, 41 each having a short back 40 extended perpendicularly by an arm 44 intended to engage with the openings 35 in the housings 31, 34 of each plastic sheet 19, 20.

The backs 42 of each tab 40, 41 are joined to one another at their free ends and over the entire height of said tabs by way of a thin triangular bead 43 constituting a fold or a hinge.

The arms 44 of each tab 40, 41 have, at their free ends and over the entire height of said tabs, a tooth 45 facing towards the corresponding back 42 and delimiting with the latter a holding trough 46.

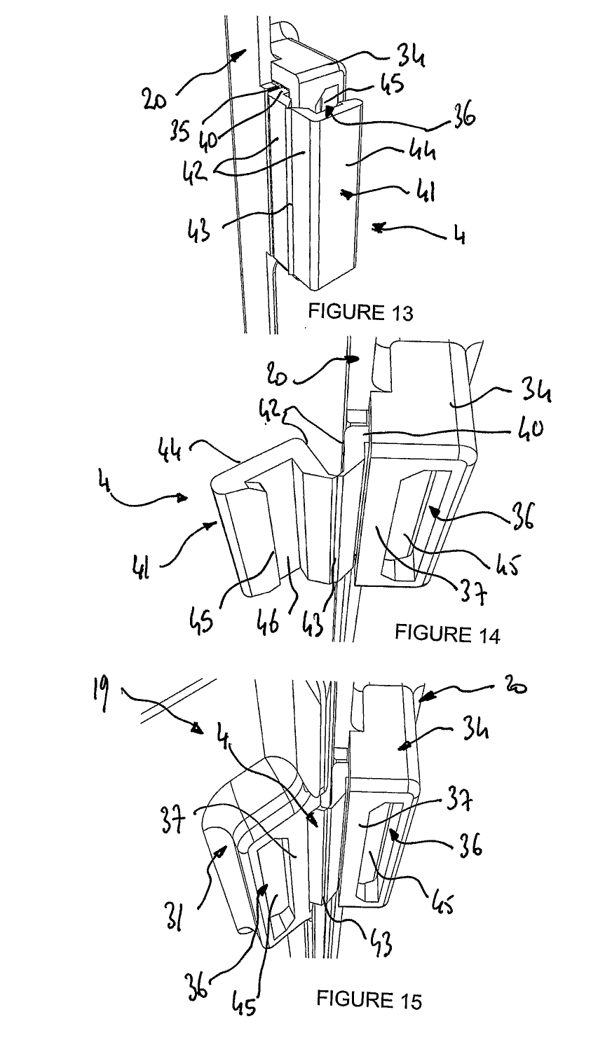

It can easily be understood from the above description how the hinge-forming linking element 4 is fitted inside the housings 31, 34 of each plastic sheet 19, 20 (FIGS. 13 to 15).

The plastic sheets 19, 20 are joined together by hinge-forming linking elements 4 before they are snap-fastened and fixed in the rigid shells 5, 6 of the casing 1.

Thus, the arms 44 of each tab 40, 41 of the linking element 4 are introduced through the opening 35 into each housing 31, 34 until the tooth 45 of each arm 44 is housed inside the notch 36 having a complementary form and the holding trough 46 holds the retaining arm 37.

When the arms 44 of each tab 40, 41 of the linking element 4 have been introduced and blocked inside each housing 31, 34, it is then possible to fit and fix the plastic sheets 19, 20 inside the rigid shells 5, 6 of the casing 1.

While the plastic sheets 19, 20 are fixed inside the rigid shells 5, 6 it is noted that the rear turned-up peripheral edges 11, 16 press against the backs 42 of each tab 40, 41 of the corresponding linking element 4, preventing said linking element 4 from being withdrawn from each housing 31, 34.

This complementary retention of the hinge-forming linking elements 4 by means of the rear turned-up peripheral edges 11, 16 of the rigid shells 5, 6 makes it impossible to withdraw said linking elements 4 without damaging said rear turned-up peripheral edges 11, 16.

On the other hand, the profile of the rear turned-up peripheral edges 11, 16, the height of the housings 31, 34 of the plastic sheets 19, 20, the position of the openings 35 in each housing 31, 34 and the profile of the linking elements 4 provide a hinge which is virtually invisible, since only the thin triangular bead 43 is slightly visible between the two rigid shells 5, 6.

Likewise, the fact that the thin triangular bead 43 of each hinge-forming linking element 4 is set back with respect to the rear turned-up peripheral edges 11, 16 of each rigid shell 5, 6 enables the production of a casing 1 having a completely flat back able to receive printing, for example.

FIGS. 16 to 18 show various nonlimiting configurations of the arrangement of the plastic sheets 19, 20 and of the holding means 50 for positioning and retaining a magnetic card or a SIM card or the like in the casing 1 according to the present invention.

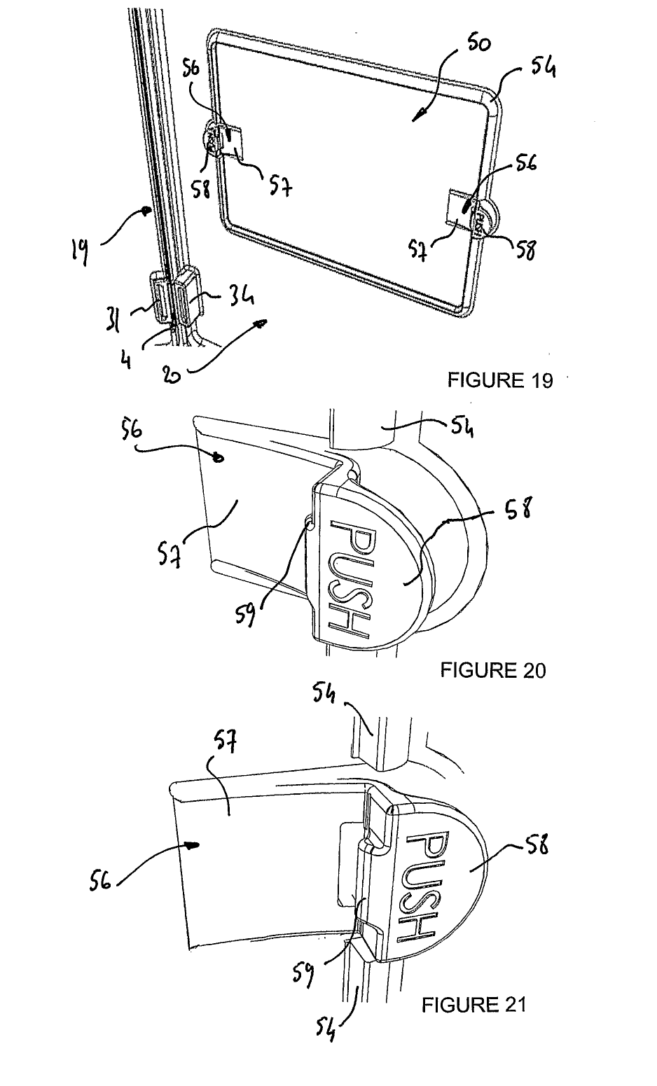

FIGS. 19 to 21 show a variant embodiment of the holding means 50 for positioning and retaining a magnetic card 60 or a SIM card or the like.

The holding means 50 consist, for example in the plastic sheet 20, of a peripheral frame 54 formed by a rib having an approximately rounded relief and delimiting an internal surface 55, the internal dimensions of which correspond to the card 60 to be retained.

The peripheral frame 54 has at least, on two opposite sides, an elastically deformable clip 56 for positioning and retaining the magnetic card 60 or a SIM card or the like.

Each clip 56 has a tab 57 cut from the bottom of the plastic sheet 20 and extended at its end by a push button 58 marked “Push” in order to exert on said tab a pressure which elastically deforms it in order to introduce the magnetic card 60 or a SIM card or the like.

The tab 57 has in its approximately vertical extension and underneath the push button 58 a protrusion 59 in the form of a lip delimiting with said tab a space for holding and retaining the magnetic card 60 or a SIM card or the like.

The pressure applied to the button 58 makes it possible to direct the lip-shaped protrusion 59 upwards or outwards in order to open the holding space and make it possible to introduce the magnetic card 60 or a SIM card or the like. It suffices then to release the pressure in order for the tab 57 and the push button 58 secured to the protrusion 59 to return to their original positions blocking the magnetic card 60 or a SIM card or the like inside the holding space.

The positioning of the card 60 or the SIM card or the like can also be carried out simply by pressing perpendicular to the surface of the shell, the card being pressed against the protrusions 59, moving them apart, and then being put into position before tightening again in order to block said card.

It goes without saying that the present invention is not limited to the illustrated examples but also protects any other arrangement, for example two card holders, one on top of the other on one of the sheets, while the other sheet has means for holding a compact disc, or vice versa.

It should also be understood that the above description has been given merely by way of example and in no way limits the scope of the invention, which would not be exceeded by replacing the details of execution described by any other equivalent.

1. An assembly method for producing a casing (1) for a multimedia storage medium and/or data storage medium, characterized in that it consists in taking pre-shaped plastic sheets (19, 20) comprising, at one of their peripheral edges, housings (31, 34) provided with locking means for joining them together, in introducing into the housings (31, 34) hinge-forming linking elements (4), in blocking the linking elements (4) inside the housings (31, 34), and in fixing the plastic sheets (19, 20) in a rigid shell (5, 6), which comprises turned-up peripheral edges (8, 9, 10, 11; 13, 14, 15, 16), such that the rear turned-up peripheral edges (11, 16) of each rigid shell (5, 6) cover the linking elements (4) in order to form an invisible hinge for opening said casing (1).

2. An assembly method for producing a casing (1) for a multimedia storage medium and/or data storage medium, characterized in that it consists in taking pre-shaped plastic sheets (19, 20) comprising, at one of their peripheral edges, housings (31, 34) provided with locking means for joining them together, in fixing the plastic sheets (19, 20) in a rigid shell (5, 6), which comprises turned-up peripheral edges (8, 9, 10, 11; 13, 14, 15, 16), such that the slots or grooves (25, 26) in the rear turned-up peripheral edges (11, 16) are positioned opposite the housings (31, 34), in introducing into the housings (31, 34) hinge-forming linking elements (4), and in blocking the linking elements (4) inside the housings (31, 34), in order to open said casing (1).

3. The assembly method for producing a casing (1) for a multimedia storage medium and/or data storage medium as claimed in claim 1, characterized in that each hinge-forming linking element (4) is made of flexible plastic comprising two tabs (40, 41) provided with a back (42), said backs (42) of each tab (40, 41) being joined together at their free ends and over the entire height of said tabs by way of a groove or a thin bead (43) constituting a fold or a hinge so that the two tabs can move relative to one another.

4. The assembly method for producing a casing (1) for a multimedia storage medium and/or data storage medium as claimed in claim 3, characterized in that the linking element (4) consists of two L-shaped tabs (40, 41) each having a short back (42) extended perpendicularly by an arm (44) which is introduced into the housings (31, 34) of each plastic sheet (19, 20) by way of an opening (35).

5. The assembly method for producing a casing (1) for a multimedia storage medium and/or data storage medium as claimed in claim 3, characterized in that each tab (40, 41) of the linking elements (4) has a shaping, a protrusion or a tooth (45) engaging with the locking means (36) having a complementary form provided in each housing (31, 34) in order to fix and retain each linking element (4).

6. The assembly method for producing a casing (1) for a multimedia storage medium and/or data storage medium as claimed in claim 5, characterized in that each tab (40, 41) of the linking elements (4) has, between the tooth (45) and the back (42), a holding trough (46) into which is introduced a retaining arm (37) belonging to each housing (31, 34) in order to complete the fixing and retaining of each linking element (4).

7. The assembly method for producing a casing (1) for a multimedia storage medium and/or data storage medium as claimed in claim 3, characterized in that, while the plastic sheets (19, 20) are fixed inside the rigid shells (5, 6), the rear turned-up peripheral edges (11, 16) press against the backs (42) of each tab (40, 41) of the corresponding linking element (4), preventing the removal of said linking element (4) from each housing (31, 34).

8. The assembly method for producing a casing (1) for a multimedia storage medium and/or data storage medium as claimed in claim 3, characterized in that the thin triangular bead (43) of each hinge-forming linking element (4) is set back with respect to the rear turned-up peripheral edges (11, 16) of each rigid shell (5, 6), enabling the production of a casing (1) having a totally flat back which is able to receive printing.

9. A casing for a multimedia storage medium and/or data storage medium, characterized in that it has a first and a second element (2, 3) each consisting of a metal shell (5, 6) secured to a plastic sheet (19, 20) and flexible hinge-forming linking elements (4) which are fixed inside housings (31, 34) respectively formed in the plates (19, 20), in order to make it possible to open said casing (1).

10. The casing for a multimedia storage medium and/or data storage medium as claimed in claim 9, characterized in that each shell (5, 6) has an upper (8, 13), lower (9, 14), front (10, 15) and rear (11, 16) turned-up peripheral edge provided with a collar (17, 18) directed towards the inside of said shells (5, 6) for snap-fastening and retaining the corresponding sheet (19, 20).

11. The casing for a multimedia storage medium and/or data storage medium as claimed in claim 9, characterized in that at least one of the sheets (19, 20) has at least one holding means (50) for positioning and retaining a magnetic card or the like.

12. The casing for a multimedia storage medium and/or data storage medium as claimed in claim 9, characterized in that at least one of the sheets (19, 20) has at least one holding means (50) for positioning and retaining a magnetic card or the like, while the other sheet comprises retaining means (27, 28) for snap-fastening a compact disc or video or the like.

13. The casing for a multimedia storage medium and/or data storage medium, as claimed in claim 11, characterized in that the holding means (50) consist of a pocket (51) and of a clip (53) secured to the corresponding sheet (19, 20).

14. The casing for a multimedia storage medium and/or data storage medium as claimed in claim 13, characterized in that the clip (53) is provided inside the pocket (51).

15. The casing for a multimedia storage medium and/or data storage medium as claimed in claim 13, characterized in that the pocket (51) has an inlet (52) located either in the upper part or to the left-hand or right-hand side.

16. The casing for a multimedia storage medium and/or data storage medium as claimed in claim 15, characterized in that the clip (53) is located opposite the inlet (52) to the pocket (51).

17. The casing for a multimedia storage medium and/or data storage medium as claimed in claim 11, characterized in that the holding means (50) consist of a peripheral frame (54) formed by a rib having an approximately rounded relief delimiting an internal surface (55), said peripheral frame (54) having, at least on two opposite edges, an elastically deformable clip (56) for positioning and retaining the magnetic card (60) or a SIM card or the like.

18. The casing for a multimedia storage medium and/or data storage medium as claimed in claim 17, characterized in that each clip (56) has a tab (57) cut from the bottom of the plastic sheet (19, 20) and extended at its end by a push button (58) in order to exert on said tab a pressure which elastically deforms it in order to introduce the magnetic card (60) or a SIM card or the like.

19. The casing for a multimedia storage medium and/or data storage medium as claimed in claim 17, characterized in that the tab (57) has in its approximately vertical extension and underneath the push button (58) a protrusion (59) in the form of a lip delimiting with said tab a space for holding and retaining the magnetic card (60) or a SIM card or the like.

20. The assembly method for producing a casing (1) for a multimedia storage medium and/or data storage medium as claimed in claim 2, characterized in that each hinge-forming linking element (4) is made of flexible plastic comprising two tabs (40, 41) provided with a back (42), said backs (42) of each tab (40, 41) being joined together at their free ends and over the entire height of said tabs by way of a groove or a thin bead (43) constituting a fold or a hinge so that the two tabs can move relative to one another.
